(19) United States
(12) Patent Application Publication
(10) Pub. No.: US 2022/0079731 A1
(43) Pub. Date: Mar. 17, 2022

(54) Ultrasonic umbrella

(71) Applicant: Michael Maurice Blank, Mount Airy, MD (US)

(72) Inventor: Michael Maurice Blank, Mount Airy, MD (US)

(21) Appl. No.: 17/300,653

(22) Filed: Sep. 13, 2021

Related U.S. Application Data
(60) Provisional application No. 63/204,149, filed on Sep. 16, 2020.

(51) Int. Cl. A61C 17/14; B08B 15/04

(52) U.S. Cl. CPC A61C 17/14; A61C 17/20; B08B 15/04

(57) ABSTRACT

There are no devices in the dental market that attach directly to the ultrasonic dental tool and immediately contain the dental aerosol.

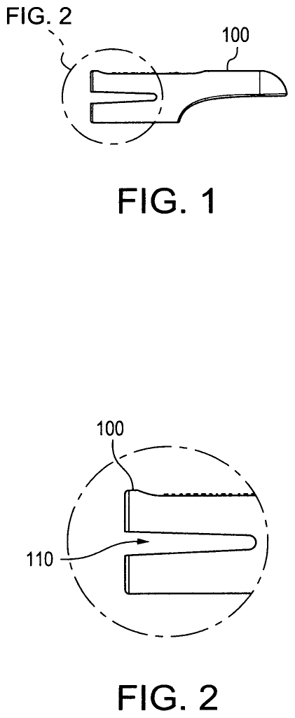

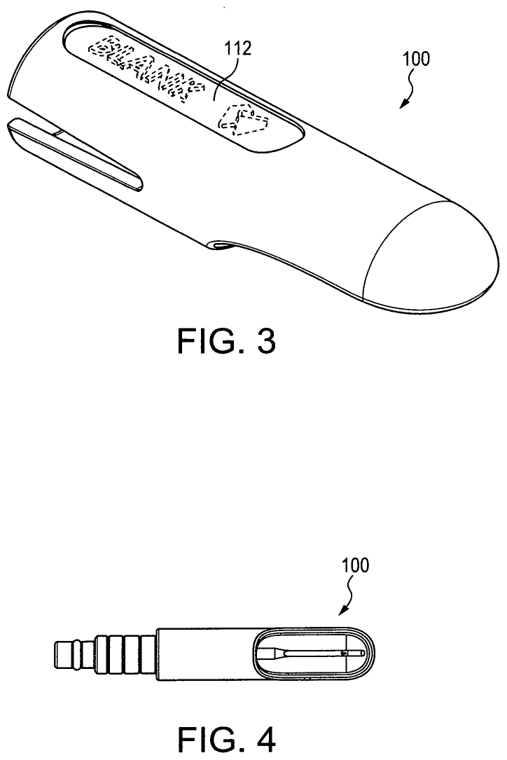

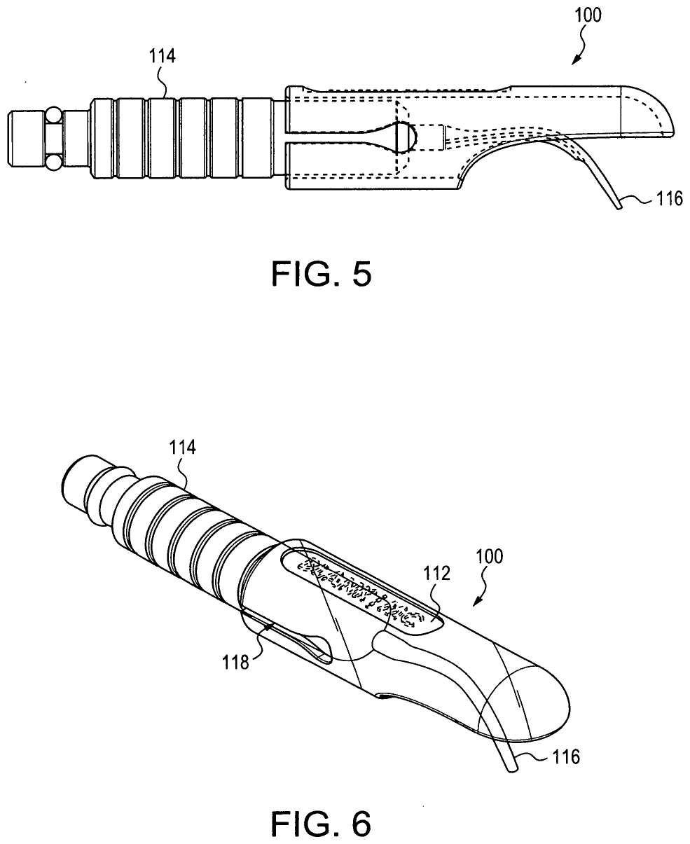

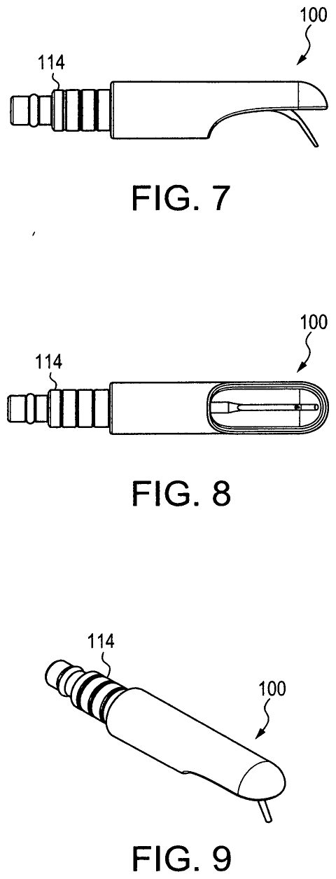

### BACKGROUND OF THE INVENTION

This invention has to do with preventing aerosol contamination from blood and saliva when using an ultrasonic dental scaler device.

Description of Ultrasonic Process Ultrasonic scaling handpieces are used for cleaning teeth. The dental handpiece vibrates a scaling tool (that is inserted into a portal in the handpiece), at ultrasonic frequencies (about 25 KHZ), in order to debride the calculus and plaque that adheres to the dentition. The dental scaler is attached to a flexible cable that connects to the main housing of the unit which contains electronics used to vibrate the scaler tool. Water also sprays out in a mist from the dental scaler tool. This aerosol allows the debrided contaminated plaque, calculus, blood and saliva to be rinsed from the dentition. It also deters the dental scaler tool from getting overheated and possibly harming the dentition. Because this aerosol contains plaque, calculus, blood and saliva, it can also possibly contain Hepatitis B germs, HIV virus, Streptococcus germs, HPV (human papilloma virus which is a cause of oral cancer and vaginal cancer), and COVID 19 virus!

### SUMMARY OF THE INVENTION

The invention is designed to decrease the aerosol emitted from ultrasonic dental handpieces. Securing the invention over the tip of the ultrasonic scaler tip will decrease the spread of this aerosol. By decreasing the spread of this aerosol, we are also decreasing the spread of Hepatitis B germs, HIV virus, Streptococcal germs, HPV (Human papilloma virus which is a cause of oral cancer and vaginal cancer), and of main concern, COVID 19. Decreasing the spread of COVID 19 virus was my major reason for inventing this device.

### BRIEF DESCRIPTION OF THE DRAWINGS

Drawing 1 is a lateral view of the Ultrasonic Umbrella. It is drawn to scale

Drawing 2 is a close up of the circled area in drawing one. This is a slit in the side of the umbrella that allows the umbrella to secure onto the ultrasonic scaling tip. (Not drawn to scale)

Drawing 3 is a Top/lateral view of the umbrella. It allows for a logo to be placed (i.e BLANK as seen in the drawing). (Not drawn to scale)

Drawing 4 is an underside view of the umbrella. (Drawn to scale)

Drawing 5 Is a lateral view of the Ultrasonic Umbrella fitted to the dental scaler tool.

Drawing 6 is a Top/lateral view of the ultrasonic Umbrella fitted to the scaler tool. Note, the material is transparent in the Ultrasonic Umbrella.

Drawing 7 Is a lateral view of the Ultrasonic Umbrella fitted to the Scaler Tool

Drawing 8 is an underside view of the Ultrasonic Umbrella fitted to the scaler tool.

Drawing 9 is a top view of the Ultrasonic Umbrella fitted to the Scaler tool.

PATENT CITATIONS

| Publication Number | Priority Date | Publication Date | Assignee | Title |
|---|---|---|---|---|
| U.S. Pat. No. 3,488,851A | 1968 Apr. 18 | 1970 Jan. 13 | Zoltan Haydu | Ultrasonic Devices |
| U.S. Pat. No. 4,110,908A | 1976 Jun. 3 | 1978 Sep. 5 | Litton Industrial | Ultrasonic Dental |
| | | | Products, Inc | Scaler |
| U.S. Pat. No. 5,775,901A | 1996 Mar. 7 | 1998 Jul. 7 | Hu-Friedy Mfg. | Insert for Ultrasonic |
| | | | Cop. LTD. | Scaler |

### DETAILED DESCRIPTION OF THE INVENTION

The invention, the Ultrasonic Umbrella, is a clear plastic convex shield that attaches to the end of a dental tool (ultrasonic scaler), and covers the top portion of the tip of the scaler. The tip of the scaler emits an aerosol and the shield collects the aerosol underneath on the concave side, thus decreasing the aerosol that is emitted from the tip. The water that collects under the shield drips back into the patients' mouth.

The invention is fabricated by pouring a liquid plastic into a mold that is the shape of the ultrasonic umbrella. It is then heated until it becomes a clear solid plastic. It is removed and can be placed on the dental tool with the concave portion being closer to the neck of the dental tool. The invention is then secured onto the dental tool by gently pushing it onto the end of the dental tool.

There are no other inventions like this one.

1. This invention is adapted to an ultrasonic dental tool with a scaler tip and blocks the aerosol that comes out of the scaler tip, thus keeping it from becoming airborne.

2. This invention collects the aerosol before it can become airborne.

3. This invention diminishes the aerosol from an ultrasonic scaler tool.
